(19) United States
(12) Patent Application Publication
(10) Pub. No.: US 2017/0217726 A1
(43) Pub. Date: Aug. 3, 2017

(54) BRAKING SYSTEM FOR HOISTED STRUCTURE AND METHOD FOR BRAKING

(71) Applicant: OTIS ELEVATOR COMPANY, Farmington, CT (US)

(72) Inventors: Brad GUILANI, Farmington, CT (US); Xiaodong LUO, East Hartford, CT (US)

(21) Appl. No.: 15/500,384

(22) PCT Filed: Aug. 6, 2015
(86) PCT No.: PCT/US2015/043920

§ 371 Date: Jan. 30, 2017

Related U.S. Application Data
(60) Provisional application No. 62/034,497, filed on Aug. 7, 2014.

(51) Int. Cl. B66B 1/44; B66B 5/22; F16D 59/02

(52) U.S. Cl. CPC B66B 1/44; F16D 59/02; B66B 5/22; F16D 2121/14

(57) ABSTRACT

A braking system for a hoisted structure includes a guide rail configured to guide the hoisted structure. Also included is a plurality of brake members operatively coupled to the hoisted structure, each of the brake members having a brake surface configured to frictionally engage the guide rail, the brake members moveable between a braking position and a non-braking position. Further included is a plurality of electronic brake member actuation mechanisms operatively coupled to the brake members and configured to actuate the brake members from the non-braking position to the braking position. Yet further included is a load sensing device operatively coupled to the hoisted structure, the load sensing device configured to detect a weight of the hoisted structure, wherein the load sensing device is in operative communication with the electronic brake member actuation mechanisms, wherein the number of actuated mechanisms is dependent on the weight of the hoisted structure.

### BACKGROUND OF THE INVENTION

The embodiments herein relate to braking systems and, more particularly, to a braking system to assist in braking a hoisted structure, as well as a method for braking such structures.

Hoisting systems, such as elevator systems and crane systems, for example, often include a hoisted structure (e.g., elevator car), a counterweight, a tension member (e.g., rope, belt, cable, etc.) that connects the hoisted structure and the counterweight. During operation of such systems, a safety braking system is configured to assist in braking the hoisted structure relative to a guide member, such as a guide rail, in the event the hoisted structure exceeds a predetermined velocity or acceleration.

Prior attempts to actuate a braking device typically require an elaborate mechanism that includes a governor, a governor rope, a tension device and a safety actuation module. The safety actuation module comprises lift rods and linkages to actuate the safeties, also referred to as a braking device. Reducing or eliminating such an elaborate mechanism, while providing a reliable and stable braking of the hoisted structure, would prove advantageous.

Additionally, braking systems often deploy all of the safety activation modules available in a safety braking event. As hoisted structure safety devices are specified according to a maximum speed and duty load of a hoisted structure installation, the safety device(s) will perform its intended function at a speed and with a fully loaded elevator car according to code requirements. In the case of a lightly loaded car, the deceleration can be more abrupt although still within code requirements.

### BRIEF DESCRIPTION OF THE INVENTION

According to one embodiment, a braking system for a hoisted structure includes a guide rail configured to guide movement of the hoisted structure. Also included is a plurality of brake members operatively coupled to the hoisted structure, each of the brake members having a brake surface configured to frictionally engage the guide rail, the brake members moveable between a braking position and a non-braking position. Further included is a plurality of electronic brake member actuation mechanisms operatively coupled to the plurality of brake members and configured to actuate the brake members from the non-braking position to the braking position. Yet further included is a load sensing device operatively coupled to the hoisted structure, the load sensing device configured to detect a weight of the hoisted structure, wherein the load sensing device is in operative communication with the plurality of electronic brake member actuation mechanisms, wherein the number of actuated mechanisms is dependent on the weight of the hoisted structure detected by the load sensing device.

According to another embodiment, a method for braking a hoisted structure is provided. The method includes weighing the hoisted structure with a load sensing device operatively coupled to the hoisted structure. The method also includes communicating the detected weight to a controller in operative communication with a plurality of electronic brake member actuation mechanisms configured to actuate a brake member from a non-braking position to a braking position. The method further includes comparing the detected weight to at least one threshold weight stored in a memory of the controller. The method yet further includes determining a number of the plurality of electronic brake member actuation mechanisms to be actuated based on the detected weight of the hoisted structure and the comparison of the detected weight to the at least one threshold weight.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of a braking system for a hoisted structure according to a first embodiment;

FIG. 2 is a schematic illustration of the braking system of FIG. 1 in a non-braking position;

FIG. 3 is a schematic illustration of the braking system of FIG. 1 in a braking position;

FIG. 4 is a front perspective view of a brake member actuation mechanism of the braking system of FIG. 1;

FIG. 5 is a rear perspective view of the brake member actuation mechanism of the braking system of FIG. 1;

FIG. 6 is a perspective view of a brake actuator housing of the brake member actuation mechanism of the braking system of FIG. 1;

FIG. 7 is a perspective view of a slider of the brake member actuation mechanism of the braking system of FIG. 1;

FIG. 8 is a perspective view of a container of the brake member actuation mechanism of the braking system of FIG. 1;

FIG. 9 is a perspective view of a braking system for a hoisted structure according to a second embodiment;

FIG. 10 is a perspective view of a brake member actuation mechanism of the braking system of FIG. 9;

FIG. 11 is a cross-sectional view of the brake member actuation mechanism of the braking system of FIG. 9;

FIG. 12 is a front view of the brake member actuation mechanism of the braking system of FIG. 9;

FIG. 13 is a schematic illustration of the braking system according to another embodiment in a non-braking position;

FIG. 14 is a schematic illustration of the braking system of FIG. 13 in a braking position;

FIG. 15 is a perspective view of a permanent magnet portion of the a brake member actuation mechanism of the braking system of FIG. 13;

FIG. 16 is a perspective view of an electromagnetic portion of the brake member actuation mechanism of the braking system of FIG. 13;

FIG. 17 is a side view of the brake member actuation mechanism of FIG. 13 according to one embodiment;

FIG. 18 is a side view of the brake member actuation mechanism of FIG. 13 according to another embodiment;

FIG. 19 is a side view of the brake member actuation mechanism of FIG. 13 in a symmetric configuration; and

FIG. 20 is a schematic illustration of a load sensing device for the braking systems described herein.

### DETAILED DESCRIPTION OF THE INVENTION

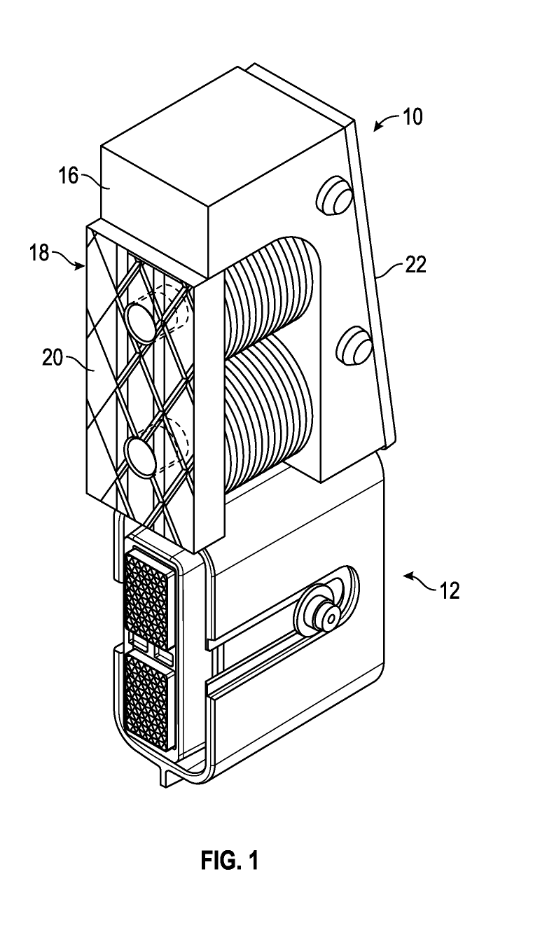

Referring to FIGS. 1-3, a brake member assembly 10 and an embodiment of a brake member actuation mechanism 12 are illustrated. The embodiments described herein relate to an overall braking system that is operable to assist in braking (e.g., slowing or stopping movement) of a hoisted structure (not illustrated) relative to a guide member, as will be described in detail below. The brake member assembly 10 and brake member actuation mechanism 12 can be used with various types of hoisted structures and various types of guide members, and the configuration and relative orientation of the hoisted structure and the guide member may vary. In one embodiment, the hoisted structure comprises an elevator car moveable within an elevator car passage.

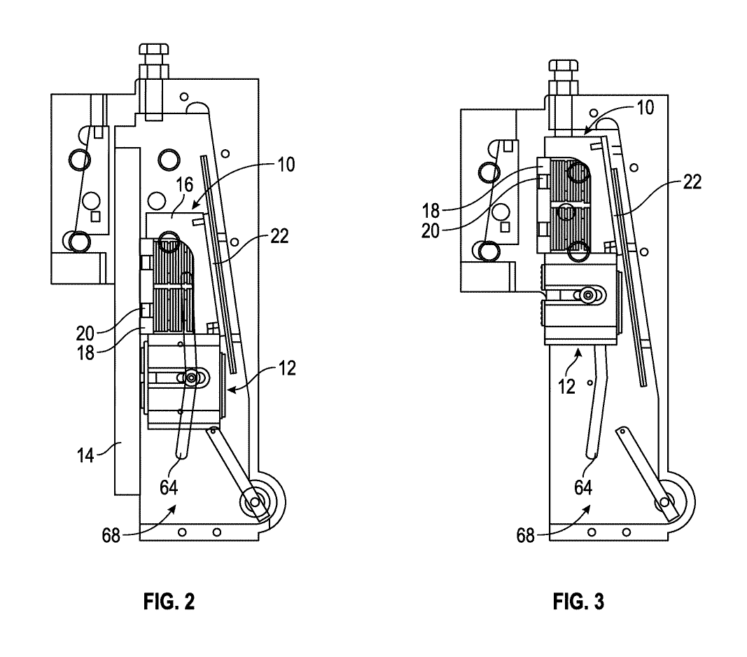

Referring to FIGS. 2 and 3, with continued reference to FIG. 1, the guide member, referred to herein as a guide rail 14, is connected to a sidewall of the elevator car passage and is configured to guide the hoisted structure. The guide rail 14 may be formed of numerous suitable materials, typically a durable metal, such as steel, for example. Irrespective of the precise material selected, in some embodiments the guide rail 14 is a ferro-magnetic material. Alternatively, in some embodiments, the guide rail 14 is formed of an alternative material, such as aluminum, that facilitates frictional engagement with a brake actuation that will be described in detail below.

The brake member assembly 10 includes a mounting structure 16 and a brake member 18. The brake member 18 is a brake pad or a similar structure suitable for repeatable braking engagement with the guide rail 14. The mounting structure 16 is connected to the hoisted structure and the brake member 18 is positioned on the mounting structure 16 in a manner that disposes the brake member 18 in proximity with the guide rail 14. The brake member 18 includes a contact surface 20 that is operable to frictionally engage the guide rail 14. As shown in FIGS. 2 and 3, the brake member assembly 10 is moveable between a non-braking position (FIG. 2) to a braking position (FIG. 3). The non-braking position is a position that the brake member assembly 10 is disposed in during normal operation of the hoisted structure. In particular, the brake member 18 is not in contact with the guide rail 14 while the brake member assembly 10 is in the non-braking position, and thus does not frictionally engage the guide rail 14. The brake member assembly 10 is composed of the mounting structure 16 in a manner that allows translation of the brake member assembly 10 relative to an outer component 68. Subsequent to translation of the brake member assembly 10, and more particularly the brake member 18, the brake member 18 is in contact with the guide rail 14, thereby frictionally engaging the guide rail 14. The mounting structure 16 includes a tapered wall 22 and the brake member assembly 10 is formed in a wedge-like configuration that drives the brake member 18 into contact with the guide rail 14 during movement from the non-braking position to the braking position. In the braking position, the frictional force between the contact surface 20 of the brake member 18 and the guide rail 14 is sufficient to stop movement of the hoisted structure relative to the guide rail 14. Although a single brake member is illustrated and described herein, it is to be appreciated that more than one brake member may be included. For example, a second brake member may be positioned on an opposite side of the guide rail 14 from that of the brake member 18, such that the brake members work in conjunction to effect braking of the hoisted structure.

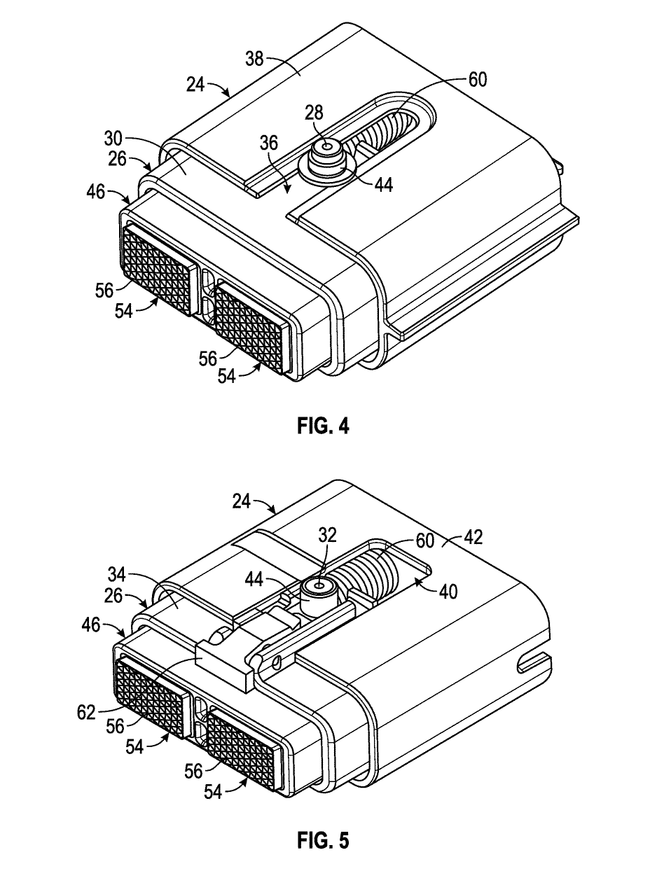

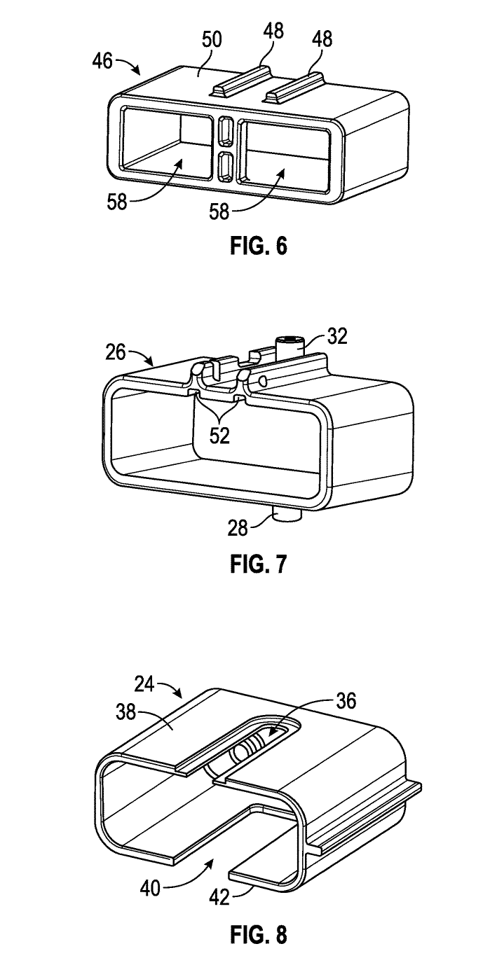

Referring now to FIGS. 4-8, an exemplary embodiment of the brake member actuation mechanism 12 is illustrated in greater detail. The brake member actuation mechanism 12 is selectively operable to actuate movement of the brake member 18 from the non-braking position to the braking position.

The brake member actuation mechanism 12 is formed of multiple components that are disposed within each other in a layered manner, with certain retained components able to slide within other components. A container 24 is an outer member that houses several components, as will be described in detail below. The container 24 is formed of a generally rectangular cross-section and is operatively coupled to the brake member assembly 10, either directly or indirectly. The operative coupling is typically made with mechanical fasteners, but alternate suitable joining methods are contemplated.

Fitted within the container 24 is a slider 26 that is retained within the container 24, but is situated in a sliding manner relative to the container 24. The slider 26 is formed of a substantially rectangular cross-section. The slider 26 includes a first protrusion 28 extending from a first side 30 of the slider 26 and a second protrusion 32 extending from a second side 34 of the slider 26. The protrusions 28, 32 are oppositely disposed from each other to extend in opposing directions relative to the main body of the slider 26. The protrusions 28, 32 are each situated at least partially within respective slots defined by the container. In particular, the first protrusion 28 is at least partially defined within, and configured to slide within, a first slot 36 defined by a first wall 38 of the container 24 and the second protrusion 32 is at least partially defined within, and configured to slide within, a second slot 40 defined by a second wall 42 of the container 24. Fitted on each of the protrusions 28, 32 is a respective bushing 44. The protrusions 28, 32 and the slots 36, 40 are on opposing walls and provide symmetric guiding of the slider 26 during sliding movement within the container 24. The symmetric guiding of the slider, in combination with the bushings 44, provide stable motion and minimized internal friction associated with relative movement of the slider 26 and the container 24.

Disposed within the slider 26 is a brake actuator housing 46 that is formed of a substantially rectangular cross-sectional geometry, as is the case with the other layered components (i.e., container 24 and slider 26). The brake actuator housing 46 is configured to move relative to the slider 26 in a sliding manner. The sliding movement of the brake actuator housing 46 within the slider 26 may be at least partially guided by one or more guiding members 48 in the form of protrusions that extend from an outer surface 50 of the brake actuator housing 46. The slider 26 includes corresponding guiding tracks 52 formed within an inner surface of the slider 26. The brake actuator housing 46 is sized to fit within the slider 26, but it is to be appreciated that a predetermined gap may be present between the brake actuator housing 46 and the slider 26 to form a small degree of “play” between the components during relative movement.

A brake actuator 54 is disposed within the brake actuator housing 46 and, as with the other components of the brake member actuation mechanism 12, the brake actuator 54 is formed of a substantially rectangular cross-sectional geometry. In some embodiments, the brake actuator 54 is formed of a ferro-magnetic material, while other embodiments include non-magnetic materials that facilitate purely frictional engagement. A contact surface 56 of the brake actuator 54 includes a textured portion that covers all or a portion of the contact surface 56. The textured portion refers to a surface condition that includes a non-smooth surface having a degree of surface roughness. For example, in non-magnetic embodiments where purely frictional engagement is relied upon, the textured portion may comprise a coefficient of friction greater than about 0.6 against steel. The contact surface 56 of the brake actuator 54 is defined as the portion of the brake actuator 54 that is exposed through one or more apertures 58 of the brake actuator housing 46.

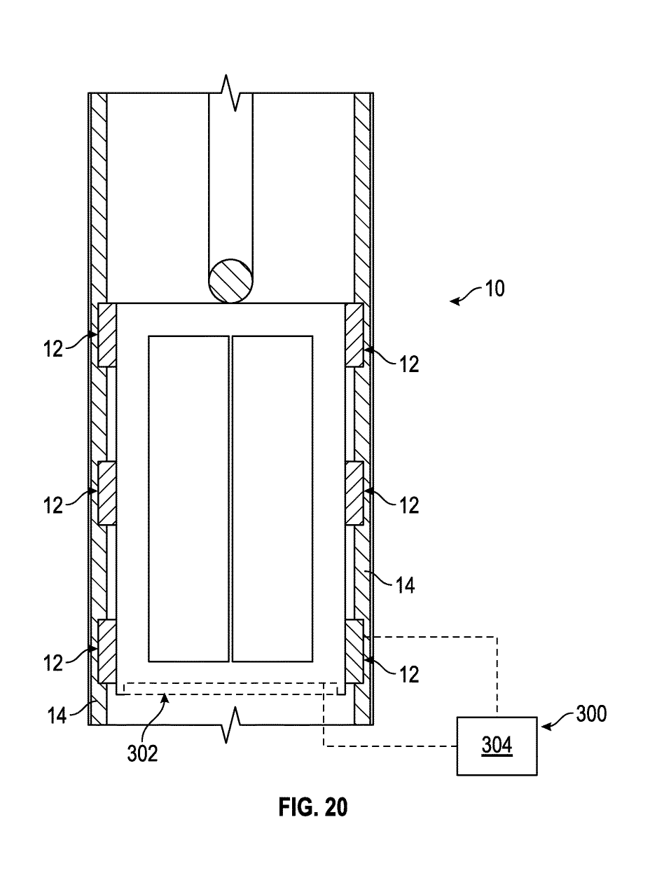

In operation, an electronic sensor and/or control system 300 (FIG. 20) is configured to monitor various parameters and conditions of the hoisted structure and to compare the monitored parameters and conditions to at least one predetermined condition. In one embodiment, the predetermined condition comprises velocity and/or acceleration of the hoisted structure. In the event that the monitored condition (e.g., over-speed, over-acceleration, etc.) exceeds the predetermined condition, the brake actuator 54 is actuated to facilitate magnetic engagement of the brake actuator 54 and the guide rail 14. Various triggering mechanisms or components may be employed to actuate the brake member actuation mechanism 12, and more specifically the brake actuator 54. In the illustrated embodiment, two springs 60 are located within the container 24 and are configured to exert a force on the brake actuator housing 46 to initiate actuation of the brake actuator 54 when latch member 62 is triggered. Although two springs are referred to above and illustrated, it is to be appreciated that a single spring may be employed or more than two springs. Irrespective of the number of springs, the total spring force is merely sufficient to overcome an opposing retaining force exerted on the brake actuator housing 46 and therefore the brake actuator 54. The retaining force comprises friction and a latch member 62 that is operatively coupled to the slider 26 and configured to engage the brake actuator housing 46 in a retained position.

As the brake actuator 54 is propelled toward the guide rail 14, the magnetic attraction between the brake actuator 54 and the guide rail 14, or the friction force between the brake actuator 54 and a non-magnetic guide rail 14, provides a normal force component included in a friction force between the brake actuator 54 and the guide rail 14. As described above, a slight gap may be present between the brake actuator housing 46 and the slider 26. Additionally, a slight gap may be present between the slider 26 and the container 24. In both cases, the side walls of the container 24 and/or the slider 26 may be tapered to define a non-uniform gap along the length of the range of travel of the slider 26 and/or the brake actuator housing 46. As noted above, a degree of play between the components provides a self-aligning benefit as the brake actuator 54 engages the guide rail 14. In particular, the normal force, and therefore the friction force, is maximized by ensuring that the entire contact surface 56 of the brake actuator 54 is in flush contact with the guide rail 14. The engagement is further enhanced by the above-described textured nature of the contact surface 56. Specifically, an enhanced friction coefficient is achieved with low deviation related to the surface condition of the guide rail 14. As such, a desirable friction coefficient is present regardless of whether the surface of the guide rail 14 is oiled or dried.

Upon magnetic or frictional engagement between the contact surface 56 of the brake actuator 54 and the guide rail 14, the frictional force causes the overall brake member actuation mechanism 12 to move upwardly relative to slots 64 within the outer component 68, such as a guiding block and/or cover (FIGS. 2 and 3). The relative movement of the brake member actuation mechanism 12 actuates similar relative movement of the brake member assembly 10. The relative movement of the brake member assembly 10 forces the contact surface 20 of the brake member 18 into frictional engagement with the guide rail 14, thereby moving to the braking position and slowing or stopping the hoisted structure, as described in detail above.

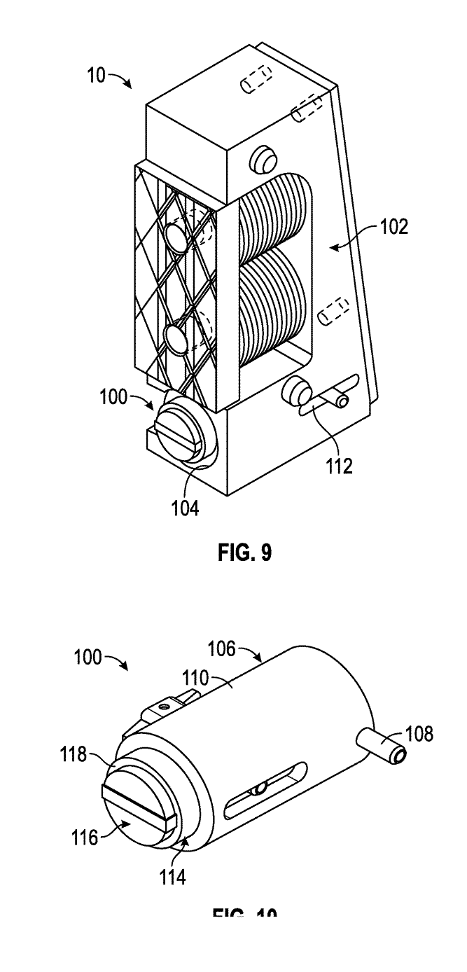

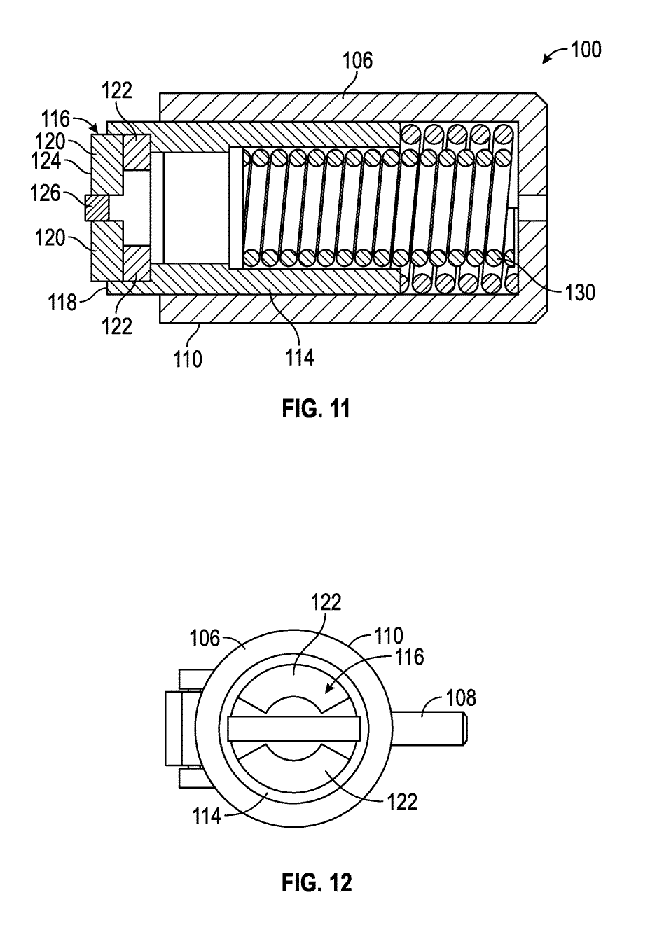

Referring now to FIGS. 9-12, a brake member actuation mechanism 100 according to another embodiment is illustrated. The brake member actuation mechanism 100 is configured to actuate movement of the brake member assembly 10 from the non-braking position to the braking position. The structure and function of the brake member assembly 10, including the brake member 18 that includes the contact surface 20 that frictionally engages the guide rail 14 in the braking position, has been described above in detail. The illustrated embodiment provides an alternative structure for actuating braking of the hoisted structure. As with the embodiments described above, two or more brake assemblies (e.g., brake members with a contact surface), as well as two or more brake member actuation mechanisms may be included to effect braking of the hoisted structure.

As shown, a single component, which may be wedge-like in construction, forms a body 102 for both the brake member assembly 10 and the brake member actuation mechanism 100. The brake member actuation mechanism 100 includes a container 104. In one embodiment, the container 104 is a cavity defined by the body 102, thereby being integrally formed therein. In another embodiment, the container 104 is an insert that is fixed within the body 102. In the illustrated embodiment, the container 104 is formed of a substantially circular cross-sectional geometry, however, it is to be understood that alternative geometries may be suitable.

Fitted within the container 104 is a slider 106 that is retained within the container 104, but is situated in a sliding manner relative to the container 104. The slider 106 is formed of a substantially circular cross-section, but alternative suitable geometries are contemplated as is the case with the container 104. The slider 106 includes at least one protrusion 108 extending from an outer surface 110 of the slider 106. The protrusion 108 is situated at least partially within a slot 112 defined by the container 104 and extends through the body 102. In particular, the protrusion 108 is configured to slide within the slot 112.

Disposed within the slider 106 is a brake actuator housing 114 that is formed of a substantially circular cross-sectional geometry, as is the case with the other layered components (i.e., container 104 and slider 106), but alternative suitable geometries are contemplated. The brake actuator housing 114 is configured to move relative to the slider 106 in a sliding manner.

A brake actuator 116 is located proximate an end 118 of the brake actuator housing 114. The brake actuator 116 comprises at least one brake pad 120 that is formed of a ferro-magnetic material and one or more magnets 122. As with all embodiments described herein, a frictional engagement may be relied upon, as discussed above. In one embodiment, the at least one magnet 122 is a half-ring magnet. The term half-ring magnet is not limited to precisely a semi-circle. Rather, any ring segment may form the magnet 122 portion(s). The at least one brake pad 120 disposed on an outer end of the magnet 122 is a metallic material configured to form a contact surface 124 of the brake actuator 116. The contact surface 124 is configured to engage the guide rail 14 and effect a friction force to actuate the brake member assembly 10 from the non-braking position to the braking position. A bumper 126 may be included to reduce the shock force associated with the initial contact between the brake pad 120 and the guide rail 14, which is particularly beneficial if the brake pad metallic material is brittle.

As described in detail above with respect to alternative embodiments, an electronic sensor and/or control system 300 (FIG. 20) is configured to monitor various parameters and conditions of the hoisted structure and to compare the monitored parameters and conditions to at least one predetermined condition. In response to the detection of the hoisted structure exceeding the predetermined condition, a triggering mechanism or component propels the brake actuator 116 into magnetic engagement with the guide rail 14. In one embodiment, a single or dual spring 130 arrangement is employed and is located within the container 104 and is configured to exert a force on the brake actuator housing 114 and/or the slider 106 to initiate actuation of the brake member actuation mechanism 100.

The magnetic engagement of the brake actuator 116 and the guide rail 14 has been described in detail above, as well as the actuation of the brake member assembly 10 from the non-braking position to the braking position, such that duplicative description is omitted for clarity.

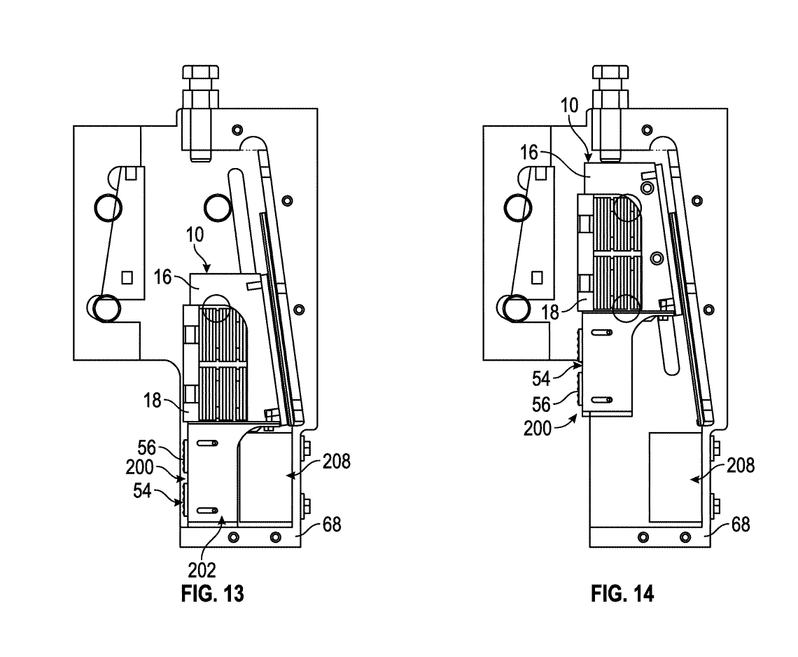

Referring now to FIGS. 13 and 14, a brake member actuation mechanism 200 according to another embodiment is illustrated. The brake member actuation mechanism 200 is configured to actuate movement of the brake member assembly 10 from the non-braking position (FIG. 13) to the braking position (FIG. 14). The structure and function of the brake member assembly 10, including the brake member 18 that includes the contact surface 20 that frictionally engages the guide rail 14 in the braking position, has been described above in detail. The illustrated embodiment provides an alternative structure for actuating braking of the hoisted structure.

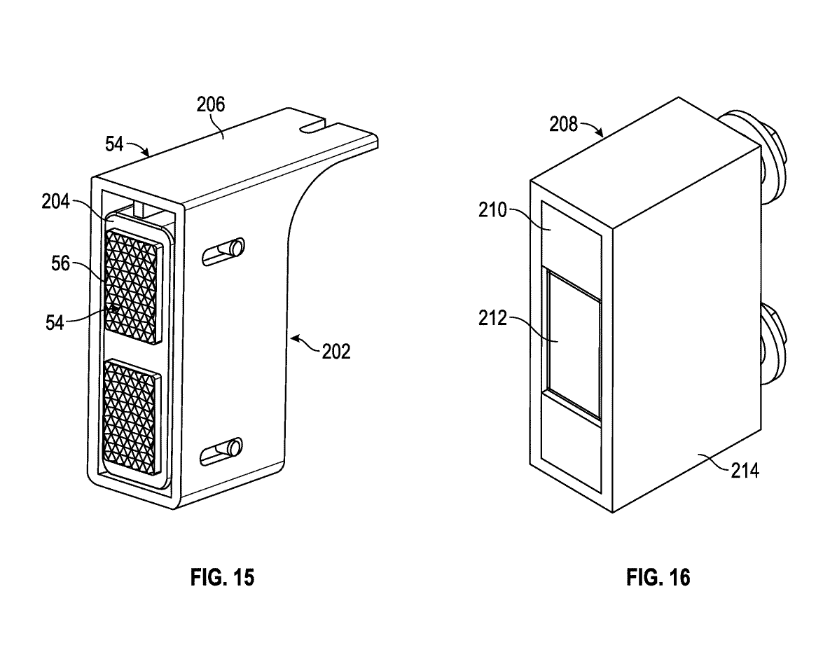

The brake member actuation mechanism 200 comprises two main components. A permanent magnet portion 202 (FIG. 15) includes the brake actuator 54 that is disposed within at least one brake actuator housing, such as an inner housing 204 and an outer housing 206, with the outermost housing being operatively coupled to the brake member assembly 10. The brake actuator 54 is formed of a ferro-magnetic material and includes the contact surface 56 having a textured portion that covers all or a portion of the contact surface 56.

As described in detail above with respect to alternative embodiments, an electronic sensor and/or control system 300 (FIG. 20) is configured to monitor various parameters and conditions of the hoisted structure and to compare the monitored parameters and conditions to at least one predetermined condition. In one embodiment, the predetermined condition comprises velocity and/or acceleration of the hoisted structure. In the event that the monitored condition (e.g., over-speed, over-acceleration, etc.) exceeds the predetermined condition, the brake actuator 54 is actuated to facilitate magnetic engagement of the brake actuator 54 and the guide rail 14. Actuation of the permanent magnet portion 202, and therefore the brake actuator 54, is achieved with an electromagnetic portion 208 (FIG. 16) of the brake member actuation mechanism 200. The electromagnetic portion 208 is formed of a core 210 surrounded by a coil 212 that is energized in response to a command from an electronic safety actuation control system 300 (FIG. 20). Upon reaching the energized condition, the coil 212 propels the brake actuator 54 toward the guide rail 14. Propulsion is achieved by the opposing magnetic force of the core 210 that is formed of a ferro-magnetic material, such as steel, and the brake actuator 54. The core 210 and the coil 212 are disposed within an electromagnetic component housing 214 that is attached to the outer component 68 described above.

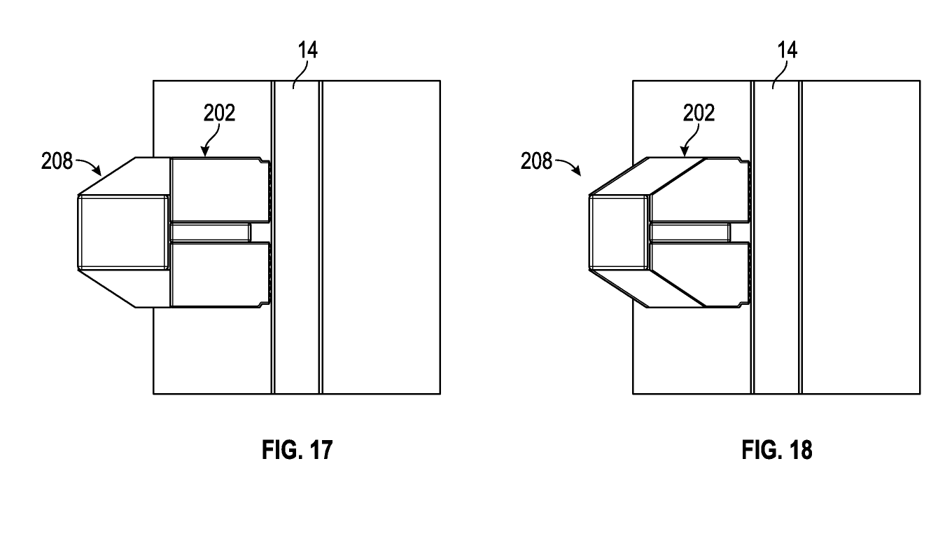

Referring to FIGS. 17 and 18, the overall geometry of the brake member actuation mechanism 200 may vary. FIG. 17 represents an embodiment having a relatively planar interface between the permanent magnet portion 202 and the electromagnetic portion 208. As shown in FIG. 18, the electromagnetic portion 208 may partially surround the permanent magnet portion 208. Such a surrounding geometry increases the propulsion force component normal to the guide rail 14, thereby requiring less magnetic force which allows for a smaller electromagnetic component.

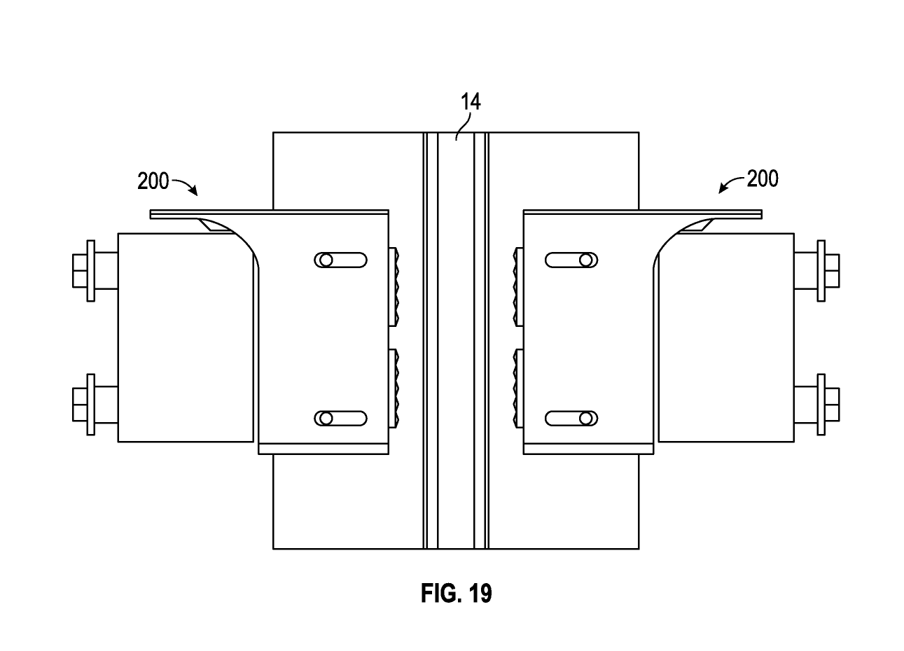

Referring to FIG. 19, as with all of the above-described embodiments, the brake member actuation mechanism 200 may be configured as a symmetric assembly, with brake member actuations mechanisms on opposing sides of the guide rail 14 or configured as an asymmetric assembly that only engages a single side of the guide rail 14.

As described in detail above with respect to alternative embodiments, an electronic sensor and/or control system 300 (FIG. 20) is configured to monitor various parameters and conditions of the hoisted structure and to compare the monitored parameters and conditions to at least one predetermined condition. In one embodiment, the predetermined condition comprises velocity and/or acceleration of the hoisted structure. In the event that the monitored condition (e.g., over-speed, over-acceleration, etc.) exceeds the predetermined condition, the brake actuator 54 is actuated to facilitate magnetic engagement of the brake actuator 54 and the guide rail 14. Actuation of the permanent magnet portion 202, and therefore the brake actuator 54, is achieved with an electromagnetic portion 208 of the brake member actuation mechanism 200. The electromagnetic portion 208 is formed of a steel core surrounded by a coil.

Referring now to FIG. 20, the above-noted control system 300 and associated components are generally illustrated. The control system 300 is in operative communication with any of the electronic brake member actuation mechanisms described above and one or more electronic sensors configured to monitor various parameters and conditions of the hoisted structure and to compare the monitored parameters and conditions to at least one predetermined condition. Although the electronic brake member actuation mechanisms are labeled with numeral 12 corresponding to the embodiment of FIG. 1 in the illustrated embodiment, it is to be appreciated that the depicted control system and associated sensors described herein may be employed with any of the embodiments described herein.

One of the electronic sensors in communication with the control system 300 is a load sensing device 302. The load sensing device 302 is operatively coupled to the hoisted structure 304. The load sensing device 302 comprises any suitable device that is configured to detect a weight of the hoisted structure at any given time. Examples of such devices comprise a continuously variable switch and a multi-step switch. As one can appreciate, suitable alternatives are contemplated. Irrespective of the precise configuration of the device, the load sensing device 302 detects the weight of the hoisted structure, including the weight of any cargo therein and communicates the detected weight to a controller 304 of the control system 300.

The control system 300 includes a memory directly or indirectly associated with the controller 304 that is configured to store and process data. The memory of the control system 300 includes at least one, but typically a plurality of threshold weights stored therein. As the weight detected by the load sensing device 302 is communicated to the control system 300, the input weight is compared to the threshold weights stored therein. In the event of an over-speed or over-acceleration condition, the detected weight determines how many of the above-described brake member actuation mechanisms 12, 100, 200 are actuated to effect braking of the hoisted structure. Therefore, the number of mechanisms actuated is dependent on the weight of the hoisted structure, as electronically detected by the load sensing device. To facilitate this weight-sensitive braking, a known minimum weight of an empty elevator car is stored in the memory of the control system 300 and a threshold weight is also stored therein. The threshold weight is a scaling factor relative to the known minimum weight, such as 25%, 50%, etc., over the known minimum weight. The above-noted percentages are merely illustrative and one can appreciate that any predetermined threshold weight may be stored in the control system 300 to achieve desirable results depending on the particular application.

Advantageously, by selectively actuating a number of mechanisms in a manner dependent upon the detected weight, the braking force and therefore deceleration felt by occupants therein is optimized. Such embodiments reduce the likelihood of a higher than necessary deceleration rate that is present in braking systems that automatically deploy all actuator mechanisms in a safety braking event.

It is to be appreciated that the number of the braking actuator mechanisms present will vary depending on the particular application. In one embodiment, at least four braking actuator mechanisms are present. The control system 300 may include any number of controllers configured to determine the number of actuator mechanisms to actuate. As such, the actuator mechanisms may be collectively controlled by a single controller or each of the actuator mechanisms may be individually and independently controlled by a number of controllers that corresponds to the number of actuator mechanisms. In particular, the number of controllers is equal to the number of actuator mechanisms in some embodiments. Other embodiments may include different controller combination arrangements, such as a case where the number of electronic brake member actuation mechanism is two times the number of controllers. In other words, each controller controls a pair of actuation mechanisms.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A braking system for a hoisted structure comprising:
a guide rail configured to guide movement of the hoisted structure;
a plurality of brake members operatively coupled to the hoisted structure, each of the brake members having a brake surface configured to frictionally engage the guide rail, the brake members moveable between a braking position and a non-braking position;
a plurality of electronic brake member actuation mechanisms operatively coupled to the plurality of brake members and configured to actuate the brake members from the non-braking position to the braking position; and
a load sensing device operatively coupled to the hoisted structure, the load sensing device configured to detect a weight of the hoisted structure, wherein the load sensing device is in operative communication with the plurality of electronic brake member actuation mechanisms, wherein the number of actuated mechanisms is dependent on the weight of the hoisted structure detected by the load sensing device.

2. The braking system of claim 1, wherein each of the plurality of electronic brake member actuation mechanisms is controlled by a single controller.

3. The braking system of claim 1, wherein each of the plurality of electronic brake member actuation mechanisms is controlled by a plurality of controllers.

4. The braking system of claim 3, wherein the number of the plurality of electronic brake member actuation mechanisms is equal to the number of the controllers.

5. The braking system of claim 3, wherein the number of the plurality of electronic brake member actuation mechanisms is two times the number of the controllers.

6. The braking system of claim 1, wherein the plurality of electronic brake member actuation mechanisms comprises at least four electronic brake member actuation mechanisms.

7. The braking system of claim 1, wherein the load sensing device is in operative communication with the plurality of electronic brake member actuation mechanisms with at least one controller configured to actuate at least one of the plurality of electronic brake member actuation mechanisms.

8. The braking system of claim 7, wherein the at least one controller comprises a memory having at least one threshold weight stored therein and configured to determine the number of electronic brake member actuation mechanisms to actuate.

9. The braking system of claim 1, wherein the plurality of electronic brake member actuation mechanisms is positioned in a symmetric arrangement about the guide rail to actuate brake members to frictionally engage opposing sides of the guide rail.

10. The braking system of claim 1, wherein the plurality of electronic brake member actuation mechanisms is positioned in an asymmetric arrangement about the guide rail to actuate brake members to frictionally engage a single side of the guide rail.

11. The braking system of claim 1, wherein the plurality of electronic brake member actuation mechanisms is positioned to engage a plurality of guide rails.

12. The braking system of claim 1, wherein the load sensing device comprises a continuously variable switch.

13. The braking system of claim 1, wherein the load sensing device comprises a multi-step switch.

14. A method for braking a hoisted structure comprising:
weighing the hoisted structure with a load sensing device operatively coupled to the hoisted structure;
communicating the detected weight to a controller in operative communication with a plurality of electronic brake member actuation mechanisms configured to actuate a brake member from a non-braking position to a braking position;
comparing the detected weight to at least one threshold weight stored in a memory of the controller; and
determining a number of the plurality of electronic brake member actuation mechanisms to be actuated based on the detected weight of the hoisted structure and the comparison of the detected weight to the at least one threshold weight.

15. The method of claim 14, wherein determining the number of the plurality of electronic brake member actuation mechanisms to actuate provides a deceleration of the hoisted structure of less than 5.0 m/s².

16. The method of claim 14, further comprising communicating the detected weight to a plurality of controllers, wherein each of the plurality of controllers is configured to actuate one of the plurality of electronic brake member actuation mechanisms.

17. The method of claim 14, further comprising communicating the detected weight to a plurality of controllers, wherein each of the plurality of controllers is configured to actuate a pair of the plurality of electronic brake member actuation mechanisms.
